(19) United States
(12) Patent Application Publication
(10) Pub. No.: US 2025/0270476 A1
(43) Pub. Date: Aug. 28, 2025

(54) ENZYME DRIVEN MECHANISM FOR FAST DISSOLUTION OF UNIT DOSE SOLIDS

(71) Applicant: ECOLAB USA INC., Saint Paul, MN (US)

(72) Inventors: Kelly Anne Rightmire, Saint Paul, MN (US); Jesse Ray Murphy, Apple Valley, MN (US); Derrick Anderson, Vadnais Heights, MN (US)

(21) Appl. No.: 19/058,988

(22) Filed: Feb. 20, 2025

Related U.S. Application Data
(60) Provisional application No. 63/556,715, filed on Feb. 22, 2024.

(51) Int. Cl. C11D 3/386; C11D 1/12; C11D 1/22; C11D 1/66; C11D 1/72; C11D 1/75; C11D 1/90; C11D 1/94; C11D 3/39; C11D 11/00

(52) U.S. Cl. CPC C11D 3/38636; C11D 1/94; C11D 3/3942; C11D 11/00; C11D 1/123; C11D 1/22; C11D 1/667; C11D 1/72; C11D 1/75; C11D 1/90

(57) ABSTRACT

This disclosure relates to solid cleaning compositions comprising an enzyme which provides controlled dissolution. The disclosure also provides for methods of manufacture and methods of using the solid cleaning compositions The solid cleaning compositions are particularly suitable for unit dose solids. Preferably, the solid cleaning compositions are alkaline cleaning compositions.

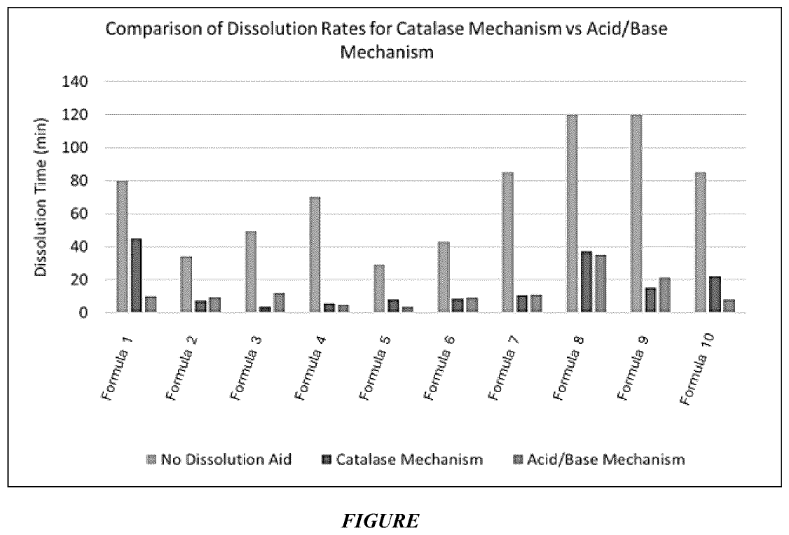

### CROSS REFERENCE TO RELATED APPLICATIONS

This application claims priority under 35 U.S.C. § 119(e) to provisional patent application U.S. Ser. No. 63/556,715, filed Feb. 22, 2024. The provisional patent application is hereby incorporated by reference in its entirety herein, including without limitation: the specification, claims, and abstract, as well as any figures, tables, appendices, or drawings thereof.

### TECHNICAL FIELD

This disclosure relates to solid cleaning compositions with an enzyme-driven dissolution mechanism. The solid cleaning compositions are particularly suitable as unit dose solids. Preferably, the solid cleaning compositions are alkaline cleaning compositions.

### BACKGROUND

Solid alkaline detergent compositions are widely used in various household and industrial cleaning processes, including, but not limited to, warewashing, laundering clothing and general surface cleaning. The greater amount of such cleaning compositions consumed consists of solid granules, tablets or pellets and solid blocks. Solid compositions are advantageous for their improved handling and safety, elimination of component segregation during transportation and storage and increased concentration of active components within the composition. These detergent compositions typically incorporate different components that harden and solidify the compositions. The solid detergents are typically used by dissolving the solid detergent with water. In some uses, a sprayer is used to dissolve the dose solid cleaning composition. Others use a dispenser, where the solid detergent is combined with a major proportion of water producing a detergent concentrate solution that is added to wash water in a washing machine to form a wash solution. In other applications, the detergent concentrate solution is used directly, commonly referred to as a use solution.

In order to be effective for these applications it is necessary that the solid detergent dissolves readily in the aqueous medium which is employed and the components are stable in the detergent concentrate solution and use solution. Various methods have been used traditionally to aid the dissolution of the solid cleaning compositions. One of the most common is an acid/base dissolution aid that utilizes an acid-base reaction to breakdown the solid detergent composition. This has proven effective for increasing the dissolution speed for quick formation of a use solution. However, this process relies on the consumption of the alkalinity source in the composition thereby increasing the alkalinity of the use solution. As a result, use of lower pH compositions has proven difficult. Accordingly, there is a need for improved dissolution mechanisms that do not alter the pH of the use solution.

### BRIEF SUMMARY OF PREFERRED EMBODIMENTS

Disclosed herein are solid cleaning compositions comprising an enzyme for controlled dissolution. The disclosure also provides for methods of manufacture and methods of use. The solid cleaning compositions comprising an enzyme driven dissolution mechanism provide various advantages over existing dissolution aids for solid cleaning compositions. For example, the enzyme driven mechanism disclosed herein provides similar speed for dissolution. The enzyme driven mechanism is compatible with wide variety of surfactants. Most importantly, the enzyme driven mechanism does not consume the alkalinity source and thus does not alter the pH of the use solution. Other advantages and benefits of the disclosed methods are described herein. The dissolution aids disclosed herein are not limited to a particular end-use detergent type or soil type and they are compatible with wide variety of surfactants and other cleaning ingredients.

A preferred embodiment is a solid cleaning composition comprising a peroxygen source, a catalase enzyme, and a surfactant. Preferably, the peroxygen source comprises a percarbonate and the peroxygen source is in a concentration of from about 50 wt. % to about 80 wt. %. Preferably, the catalase enzyme is in a concentration of from about 0.2 wt. % to about 4 wt. %. Preferably, the surfactant is in a concentration of from about 1 wt. % to about 35 wt. %. the solid cleaning composition can optionally include one or more additional functional ingredients. Preferably, the solid cleaning composition is substantially free of a dissolution aid other than the catalase.

A preferred embodiment is a method of cleaning a surface comprising: contacting a solid cleaning composition with water and dissolving the solid cleaning composition to form a use solution; and contacting a soiled surface with the use solution; wherein the use solution has a pH of from about 3 to about 8; the solid cleaning composition comprising a peroxygen source, a catalase enzyme, and a surfactant. Preferably, the peroxygen source comprises a percarbonate and the peroxygen source is in a concentration of from about 50 wt. % to about 80 wt. %. Preferably, the catalase enzyme is in a concentration of from about 0.2 wt. % to about 4 wt. %. Preferably, the surfactant is in a concentration of from about 1 wt. % to about 35 wt. %. the solid cleaning composition can optionally include one or more additional functional ingredients. Preferably, the solid cleaning composition is substantially free of a dissolution aid other than the catalase.

A preferred embodiment is a method of manufacturing a solid cleaning composition of comprising: mixing a peroxygen source, a catalase enzyme, and a surfactant; and forming the solid cleaning composition. Preferably, the peroxygen source comprises a percarbonate and the peroxygen source is in a concentration of from about 50 wt. % to about 80 wt. %. Preferably, the catalase enzyme is in a concentration of from about 0.2 wt. % to about 4 wt. %. Preferably, the surfactant is in a concentration of from about 1 wt. % to about 35 wt. %. the solid cleaning composition can optionally include one or more additional functional ingredients. Preferably, the solid cleaning composition is substantially free of a dissolution aid other than the catalase.

### BRIEF DESCRIPTION OF THE FIGURES

The FIGURE is a graph illustrating the dissolution rates for each of the ten formulas tested using the enzyme-driven dissolution method, the acid/base dissolution method, and the controls formulas having no dissolution aid.

Various embodiments of this disclosure are described with reference to the figures. Reference to Figures, and any embodiments disclosed therein, does not limit the scope of the invention. Figures represented herein are not limitations to the various embodiments according to the disclosure and are presented as examples and non-limiting embodiments of the inventions disclosed herein.

### DETAILED DESCRIPTION

The present disclosure relates to solid cleaning compositions comprising an enzyme for controlled dissolution, their manufacture, and methods of use. Beneficially, the enzyme provides a mechanism for dissolution of the solid cleaning compositions. In an embodiment, the solid cleaning compositions are unit dose compositions.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, concentration, mass, molecular weight, volume, time, temperature, and pH. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “hard surface” refers to a solid, substantially non-flexible surface such as a counter top, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein the term “molecular weight” refers to the mass of a molecule based on the chemical formula. The term “molecular weight” in referring to a polymer refers to the weight average molecular weight (Mw) that is calculated by taking the weight average of the molecular weights of individual monomers in a polymer. The specific method used to determine molecular weight will depend on the nature of the molecule and the available techniques. Examples of common methods to determine molecular weight include mass spectrometry, size exclusion chromatography (SEC), light scattering, osmometry, chemical analysis and viscometry.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

The term “surfactant” or “surface active agent” refers to an organic chemical that when added to a liquid changes the properties of that liquid at a surface.

As used herein, the term “unit dose solid” refers to a composition unit sized so that the entire unit is used during a single cleaning cycle. When the solid hard surface cleaning composition is provided as a unit dose, it is preferably provided as a pressed solid, cast solid, an extruded pellet, or a tablet having a size of between approximately 1 gram and approximately 50 grams.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the invention include polyethylene terephthalate (PET) polystyrene polyamide.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Solid Cleaning Compositions

Disclosed herein are solid cleaning compositions comprising an enzyme, which provides controlled dissolution of the solid cleaning compositions. This enzyme-driven mechanism for controlled dissolution makes the solid cleaning compositions particularly suitable for use as unit dose solids. Thus, in a preferred embodiment, the solid cleaning compositions are unit dose solids.

According to embodiments, the solid cleaning compositions comprise a peroxygent source, a catalase enzyme, and a surfactant. Exemplary solid cleaning compositions are shown in Table 1 in weight percentages. While the components may have a percent actives of 100%, it is noted that Table 1 does not recite the percent actives of the components, but rather, recite the total weight percentage of the raw materials (i.e. active concentration plus inert ingredients).

TABLE 1
Solid Concentrated Cleaning Compositions

| | First Example | Second Example | Third Example |
|---|---|---|---|
| Material | Range wt. % | Range wt. % | Range wt. % |
| Peroxygen source | 50-85 | 60-80 | 70-80 |
| Catalase Enzyme | 0.2-4 | 0.3-3 | 0.5-2 |
| Surfactant | 1-35 | 5-25 | 5-15 |
| Optional Functional | 0-25 | 0.5-25 | 1-25 |
| Ingredients | | | |

The solid cleaning compositions are solid concentrates that are diluted to form use solutions. In general, a concentrate refers to a composition that is intended to be diluted with water to provide a use solution that contacts an object to provide the desired cleaning, sanitizing, or the like. The solid cleaning composition that contacts the articles to be washed can be referred to as a concentrate or a use solution dependent upon the formulation employed in methods. It should be understood that the concentration of the components in the solid cleaning compositions will vary depending on the concentrated nature of the formulation and the desired concentration at use.

The solid cleaning compositions provide shelf stable solid compositions. The solid hard surface cleaning compositions are shelf stable, including at elevated storage temperatures and humidity, including for example at temperatures up to at least 50° C. for at least 8 weeks with substantially no change in dimension, substantially no weeping (i.e. liquid leaching from solid or visible on the surface of the solid) and/or other visual signs of instability (e.g. cracks, blooming, or any user observations indicating instability). The stability of the solid compositions, namely tablets, are important for maintained dissolution rates at use as the acid and/or alkalinity sources are not prematurely reacting which would negatively impact the optimal dissolution rate.

Beneficially the solid compositions are shelf stability at room temperature or ambient temperatures for at least about 1 year for tablet compositions. It is a significant benefit for the solid cleaning compositions to exhibit both solid stability and use composition stability for extended periods of time.

In some embodiments, a ready-to-use solution of the solid cleaning concentrate diluted to form a use composition is shelf stable, or has a shelf-life, of one day, or more than one day, or more than one week, or more than two weeks. In an embodiment, the ready-to-use diluted form of the solid compositions have a shelf-life of about two weeks.

### pH Upon Dilution

In some aspects, the solid compositions when diluted to form a use composition have a pH of at least about 3.0, at least about 3.1, at least about 3.2, at least about 3.3, at least about 3.4, at least about 3.5, at least about 3.6, at least about 3.7, at least about 3.8, at least about 3.9, at least about 4.0, at least about 4.1, at least about 4.2, at least about 4.3, at least about 4.4, at least about 4.5, at least about 4.6, at least about 4.7, at least about 4.8, at least about 4.9, at least about 5.0, at least about 5.1, at least about 5.2, at least about 5.3, at least about 5.4, at least about 5.5, at least about 5.6, at least about 5.7, at least about 5.8, at least about 5.9, at least about 6.0, at least about 6.1, at least about 6.2, at least about 6.3, at least about 6.4, at least about 6.5 at least about 6.6, at least about 6.7, at least about 6.8, at least about 6.9, at least about 7.0, at least about 7.1, at least about 7.2, at least about 7.3, at least about 7.4, at least about 7.5; in some embodiments at least about 7.6, at least about 7.7, at least about 7.8, at least about 7.9, or at least about 8.0. Further, the solid compositions when diluted to form a use composition have a pH of less than about 9.5, less than about 9.4, less than about 9.3, less than about 9.2, less than about 9.1, less than about 9.0, less than about 8.9, less than about 8.8, less than about 8.7, less than about 8.6, less than about 8.5; in some embodiments less than about 8.4, less than about 8.3, less than about 8.2, less than about 8.1, or less than about 8.0.

The solid cleaning compositions can be diluted in any ratio to provide a desired concentration of ingredients upon use. Preferred dilution ratios of solid cleaning composition to water include, but are not limited to about 1:1 to about 1:1000, more preferably 1:2 to about 1:500, still more preferably 1:3 to about 1:450, yet more preferably about 1:4 to about 1:400, most preferably about 1:5 to about 1:300.

### Peroxygen Source

The cleaning compositions include a peroxygen source. Preferred peroxygen sources are solid and most preferably can contribute or serve as a solidification agent for the composition. A preferred peroxygen source includes, but is not limited to, a percarbonate. The percarbonate will have an alkali metal such as sodium or potassium. The percarbonate can be in an amount specific for a particular end use formulations depending on the pH desired for the type of cleaning. It is expected that the percarbonate will be in a concentration of at least about 50 wt. %, at least about 55 wt. %, at least about 60 wt. %, at least about 65 wt. %, at least about 70 wt. %. Preferably, the percarbonate is in an amount of from about 50 wt. % to about 85 wt. %, 60 wt. % to about 80 wt. %, or about 70 wt. % to about 80 wt. %.

### Catalase Enzyme

The enzyme driven mechanism of dissolution includes a catalase enzyme. The catalase enzyme interacts with the peroxygen source. Suitable catalase enzymes can be naturally-derived or synthetic. They can be obtained from a variety of commercial sources.

The catalase enzyme is provided in an amount from about 0.2 wt. % to about 4 wt. %, more preferably from about 0.3 wt. % to about 3 wt. %, still more preferably from about 0.4 wt. % to about 2.5 wt. %, most preferably from about 0.5 wt. % to about 2 wt. %.

### Surfactant

One or more surfactants are included in the cleaning compositions. The type of surfactants can be chosen based on the end use of the cleaning composition and may be impacted the types of soils to be cleaned, types of surface to be cleaned, the amount of foam if any, and compatibility with other ingredients. As shown herein, in the examples, the enzyme driven dissolution mechanism is suitable for use with all surfactant classes. Accordingly, the type of surfactants in the solid cleaning compositions can vary. Preferred surfactant species are set forth below; however, this list is non-limiting and some may not be suitable for different types of end use cleaning applications. These surfactants are compatible with the enzyme driven dissolution method though.

Suitable surfactants include, cationic surfactants, nonionic surfactants, amphoteric surfactants, zwitterionic surfactants, anionic surfactants, and mixtures thereof. Preferred surfactants suitable for different end use compositions are described in greater detail below.

Preferably the surfactant is in a concentration of from about 1 wt. % to about 35 wt. %, 5 wt. % to about 25 wt. %, or about 10 wt. % to about 20 wt. %.

### Nonionic Surfactants

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Examples of nonionic low foaming surfactants include:

Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. The hydrophobic portion of the molecule weighs from about 2,100 to about 6,700 with the central hydrophile including 10% by weight to 80% by weight of the final molecule.

Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics. Additional examples of effective low foaming nonionics include:

The alkylphenoxypolyethoxyalkanols of U.S. Pat. No. 2,903,486 issued Sep. 8, 1959 to Brown et al. and represented by the formula

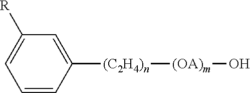

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)ₛN—(EO)ₜH, R²⁰—(PO)ₛN—(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)ᵥ—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the compositions of the invention include alcohol alkoxylates, EO/PO block copolymers, alkylphenol alkoxylates, and the like.

### Semi-Polar Nonionic Surfactants

The semi-polar type of nonionic surface active agents are another class of nonionic surfactant useful in compositions of the present invention. Generally, semi-polar nonionics are high foamers and foam stabilizers, which can limit their application in CIP systems. However, within compositional embodiments of this invention designed for high foam cleaning methodology, semi-polar nonionics would have immediate utility. The semi-polar nonionic surfactants include the amine oxides, phosphine oxides, sulfoxides and their alkoxylated derivatives.

Amine oxides are tertiary amine oxides corresponding to the general formula:

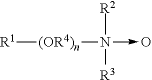

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl) amine oxide, 3,6,9-trioctadecyldimethylamine oxide and 3-dodecoxy-2-hydroxypropyldi-(2-hydroxyethyl) amine oxide.

Useful semi-polar nonionic surfactants also include the water soluble phosphine oxides having the following structure:

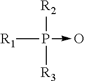

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

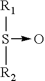

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the invention include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions of the present invention include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

### Anionic Surfactants

Also useful in the present invention are surface active substances which are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility. As those skilled in the art understand, anionics are excellent detersive surfactants and are therefore favored additions to heavy duty detergent compositions.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N-(C₁-C₄ alkyl) and —N-(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

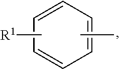

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

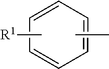

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

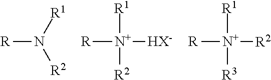

in which, R represents an alkyl chain, R′, R″, and R″′ may be either alkyl chains or aryl groups or hydrogen and X represents an anion. The amine salts and quaternary ammonium compounds are preferred for practical use in this invention due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present invention include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

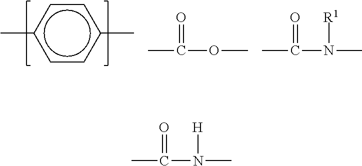

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens. Y can be a group including, but not limited to:

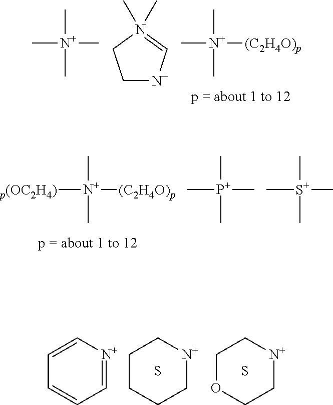

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

### Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present invention generally have the general formula:

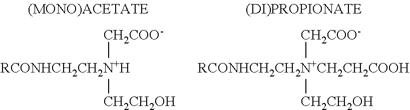

### Neutral pH Zwitternion

### Amphoteric Sulfonate

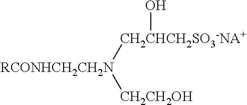

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R=C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N (2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl—C(O)—NH—CH₂—CH₂—N⁺(CH₂—CH₂—CO₂Na)₂—CH₂—CH₂—OH or C₁₂-alkyl—C(O)—N(H)—CH₂—CH₂—N⁺(CH₂—CO₂Na)2—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

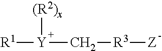

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N (2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

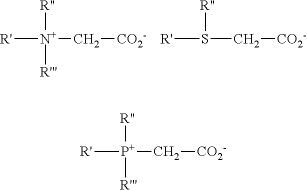

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present invention include those compounds having the formula (R(R¹)₂N⁺R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated in their entirety.

### Additional Optional Functional Ingredients

The unit dose solid enzyme driven dissolution method is suitable for use with a variety of cleaning compositions provided in unit dosages. Preferred unit dose solids include, but are not limited to, warewash detergents, laundry detergents, oven cleaners, and hard surface cleaners. Given the different potential applications for unit dose solids, the ingredients can vary by application and soil. This disclosure is not limited by end use applications and ingredients employed for particular end-uses and soils. As demonstrated via the data herein, the enzyme driven dissolution method is compatible with a broad variety of surfactant types which can be useful for many different cleaning applications and soils. Below is a preferred list of potential ingredients; however, this list is not conclusive.

The optional functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the solid cleaning compositions may include an acid source, an alkalinity source, a corrosion inhibitor, an optical brightener, a defoaming agent, an anti-redeposition agent, a bleaching agent, a solubility modifier, a dispersant, a metal protecting agent, a preservative, a filler, a builder, a hardening agent, a cleaning enzyme, an aesthetic enhancing agent including an odorant and/or dye, a hydrotrope, a buffer, additional cleaning agents, a sanitizer/anti-microbial agent, and mixtures thereof. Beneficially, the compositions provided herein do not require traditional dissolution aids and in some preferred embodiments, dissolution aids (other than the catalase enzyme) are not present or in an amount of less than about 1 wt. %, less than about 0.5 wt. %, less than about 0.4 wt. %, less than about 0.3 wt. %, less than about 0.2 wt. %, or less than about 0.1 wt. %.

### Acid Source

In some embodiments, the cleaning compositions can optionally include an acid source. Suitable acid sources can include organic and/or inorganic acids. Examples of suitable organic acids include carboxylic acids such as but not limited to hydroxyacetic (glycolic) acid, citric acid, formic acid, acetic acid, propionic acid, butyric acid, valeric acid, caproic acid, trichloroacetic acid, urea hydrochloride, and benzoic acid, among others. Organic dicarboxylic acids such as oxalic acid, malonic acid, gluconic acid, itaconic acid, succinic acid, glutaric acid, maleic acid, fumaric acid, adipic acid, and terephthalic acid among others are also useful in accordance with the invention. Any combination of these organic acids may also be used intermixed or with other organic acids which allow adequate formation of the composition of the invention.

Inorganic acids useful in accordance with the invention include sulfuric acid, sulfamic acid, methylsulfamic acid, hydrochloric acid, hydrobromic acid, and nitric acid among others. These acids may also be used in combination with other inorganic acids or with those organic acids mentioned above. In a preferred embodiment, the acid is an inorganic acid.

In some embodiments of the invention, a cleaning composition can have an acidic pH. In such an embodiment, the pH is preferably between 1 and 7. In another aspect of the invention, the acid source can be included as a pH modifier or neutralizer in a basic composition to achieve a desired pH.

Preferably the acid has an aqueous solubility between 0.1 g/L and 1500 g/L at 20° C., more preferably between 0.25 g/L and 500 g/L at 20° C., most preferably between 0.25 and 100 g/L at 20° C. As used herein, the g/L description refers to the mass of acid added with sufficient aqueous medium (e.g., water) to form one liter of solution.

Preferably the acid is a polycarboxylic acid. More preferably, the acid is a polycarboxylic acid having between 2 and 4 carboxyl groups. More preferably the polycarboxylic acid is a dicarboxylic acid or a tricarboxylic acid. Preferred acids include, but are not limited to, citric acid, adipic acid, ethylenediamine tetra acetic acid, isocitric acid, glutamic acid, glutaric acid, malic acid, propane-1,2,3-tricarboxylic acid, succinic acid, tartaric acid, salts of the foregoing, and mixtures thereof.

If included, the acid source is preferably in an amount from about 0.01 wt. % to about 35 wt. %, about 0.5 wt. % to about 30 wt. %, from about 1 wt. % to about 25 wt. %. It should be understood that if included, the acid is not contributing to the dissolution of the solid cleaning composition but is added for the purpose of reaching a targeted pH in the use solution.

### Alkalinity Source

In addition to the peroxygen source, an alkalinity source can optionally be included in the solid cleaning compositions. Suitable alkalinity sources can include, but are not limited to, an alkali metal hydroxide, an alkali metal carbonate, bicarbonate, a sesquicarbonate, an alkali metal silicate, a metal borate, an alkanolamine, an amino alcohol and mixtures thereof. Preferred alkali metal carbonates include, but are not limited to sodium or potassium carbonate, bicarbonate, sesquicarbonate, and mixtures thereof. Preferred alkali metal hydroxides include, but are not limited to, sodium hydroxide, potassium hydroxide, and mixtures thereof. Preferred alkali metal silicates include, but are not limited to, sodium silicate, potassium silicate, sodium metasilicate, potassium metasilicate, and mixtures thereof. Preferred alkanolamines include, but are not limited to, monoethanolamine, monopropanolamine, diethanolamine, dipropanolamine, triethanolamine, tripropanolamine and mixtures thereof. Preferred amino alcohols include, but are not limited to, 2-amino-2-methyl-1-propanol, 2-amino-1-butanol, 2-amino-2-methyl-1,3-propanediol, 2-amino-2-ethyl-1,3-propanediol, hydroxymethyl aminomethane, and mixtures thereof.

If included, the alkalinity source is preferably in an amount from about 0.01 wt. % to about 35 wt. %, about 0.5 wt. % to about 30 wt. %, from about 1 wt. % to about 25 wt. %. It should be understood that if included, the alkalinity source is not consumed during dissolution of the solid cleaning composition but is added for purpose of reaching a targeted pH in the use solution and for cleaning properties provided by alkaline conditions.

### Anti-Redeposition Agent

The cleaning compositions can optionally include an anti-redeposition agent capable of facilitating sustained suspension of soils in a cleaning or rinse solution and preventing removed soils from being redeposited onto the substrate being cleaned and/or rinsed. Some examples of suitable anti-redeposition agents can include fatty acid amides, fluorocarbon surfactants, complex phosphate esters, styrene maleic anhydride copolymers, and cellulosic derivatives such as hydroxyethyl cellulose, hydroxypropyl cellulose, and the like. A cleaning composition can include up to about 10 wt. %, and in some embodiments, in the range of about 1 to about 5 wt. %, of an anti-redeposition agent.

### Bleaching Agents

The cleaning compositions can optionally include bleaching agents. Bleaching agents can be used for lightening or whitening a substrate and can include bleaching compounds capable of liberating an active halogen species, such as Cl₂, Br₂, —OCl⁻ and/or —OBr⁻, or the like, under conditions typically encountered during the cleansing process. Suitable bleaching agents for use can include, for example, chlorine-containing compounds such as a chlorine, a hypochlorite, chloramines, of the like. Some examples of halogen-releasing compounds include the alkali metal dichloroisocyanurates, chlorinated trisodium phosphate, the alkali metal hypochlorites, monochloramine and dichloroamine, and the like. Encapsulated chlorine sources may also be used to enhance the stability of the chlorine source in the composition (see, for example, U.S. Pat. Nos. 4,618,914 and 4,830,773, the disclosures of which are incorporated by reference herein). A bleaching agent may also include an agent containing or acting as a source of active oxygen. The active oxygen compound acts to provide a source of active oxygen, for example, may release active oxygen in aqueous solutions. An active oxygen compound can be inorganic or organic or can be a mixture thereof. Some examples of active oxygen compound include peroxygen compounds, or peroxygen compound adducts. Some examples of active oxygen compounds or sources include hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like. A cleaning composition may include a minor but effective amount of a bleaching agent, for example, in some embodiments, in the range of up to about 10 wt. %, and in some embodiments, in the range of about 0.1 to about 6 wt. %.

### Builders

The solid cleaning compositions can optionally include a builder, which can include chelant or chelating agent or a water conditioning polymer, or mixture thereof. Various builders can be employed as water conditioning agents to coordinate (i.e., bind) the metal ions commonly found in natural water to prevent the metal ions from interfering with the action of the other detersive ingredients of a cleaning composition. In general, chelants can generally be referred to as a type of builder and may also function as a threshold agent when included in an effective amount.

A preferred builder is an aminocarboxylic acid chelant including, for example, methylglycinediacetic acid (MGDA), N,N-dicarboxymethyl glutamic acid (GLDA), N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof.

Additional builders include: phosphonates, including phosphonic acid; phosphates, including condensed phosphates such as sodium and potassium orthophosphate, sodium and potassium pyrophosphate, sodium tripolyphosphate, sodium hexametaphosphate, and the like; organic chelating agents, including both polymeric and small molecule chelating agents such as organocarboxylate compounds or organophosphate chelating agents; polymeric chelating agents, including polyanionic compositions such as polyacrylic acid compounds.

The builder may also be a polymer including for example water soluble polycarboxylate polymers such as homopolymeric and copolymeric compositions with pendant (—COOH) carboxylic acid groups and include polyacrylic acid, polymethacrylic acid, polymaleic acid, acrylic acid-methacrylic acid copolymers, acrylic-maleic copolymers, hydrolyzed polyacrylamide, hydrolyzed methacrylamide, hydrolyzed acrylamide-methacrylamide copolymers, hydrolyzed polyacrylonitrile, hydrolyzed polymethacrylonitrile, hydrolyzed acrylonitrile methacrylonitrile copolymers, or mixtures thereof. Water soluble salts or partial salts of these polymers or copolymers such as their respective alkali metal (for example, sodium or potassium) or ammonium salts can also be used. The weight average molecular weight of the polymers is from about 400 to about 20,000 g/mol. An example of commercially available polycarboxylic acids (polycarboxylates) is ACUSOL 445 which is a homopolymer of acrylic acid with an average molecular weight of 4500 (Dow Chemicals). ACUSOL 445 is available as partially neutralized, liquid detergent polymer.

Exemplary polymers include polyacrylic acid, the partial sodium salts of polyacrylic acid or sodium polyacrylate having an average molecular weight within the range of 4000 to 8000. Further exemplary polymers include polycarboxylates, such as polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, and hydrolyzed acrylonitrile-methacrylonitrile copolymers.

In an exemplary embodiment the builder includes an aminocarboxylic acid that is one or more of methylglycinediacetic acid (MGDA), N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid, and triethylenetetraaminehexaacetic acid, and a further builder or water conditioning polymer that is a homopolymer of acrylic acid.

If included, the solid cleaning compositions include from about 0.1 wt. % to about 45 wt. %, from about 0.5 wt. % to about 40 wt. %, from about 1 wt. % to about 35 wt. %, from about 5 wt. % to about 30 wt. %, or from about 5 wt. % to about 25 wt. % of the builder.

### Corrosion Inhibitors

The solid cleaning compositions can optionally include one or more corrosion inhibitors for use in cleaning of alkaline sensitive metals such as aluminum or aluminum containing alloys. The corrosion inhibitors must not negatively interfere with the solid and/or use composition stability. Preferred corrosion inhibitors that maintain stability of the compositions include silicates and metasilicates, preferably alkali metal silicates and metasilicates, such as sodium silicate and sodium metasilicate. Anhydrous forms may be employed such as sodium metasilicate anhydrous.

### Cleaning Enzyme

The solid cleaning compositions can optionally include one or more cleaning enzymes in addition to the catalase enzyme. Cleaning enzymes as used herein refers to enzymes useful for cleaning and soil removal. Preferred cleaning enzymes include, but are not limited to, amylases, cellulases, lipases, proteases, and mixtures thereof.

If included, the solid cleaning compositions include from about 0.1 wt. % to about 25wt. %, from about 0.5 wt. % to about 20 wt. %, from about 1 wt. % to about 15 wt. % of the cleaning enzyme.

### Dyes/Odorants

Various dyes, odorants including perfumes, and other aesthetic enhancing agents may also be included in the solid cleaning compositions. Dyes may be included to alter the appearance of the composition, as for example, FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Odorants including, fragrances and perfumes, that may be included in the solid cleaning compositions include, for example, terpenoids such as citronellol, aldehydes such as amyl cinnamaldehyde, a jasmine such as C1S-jasmine or jasmal, vanillin, and the like.

### Fillers

The solid cleaning compositions can optionally include a minor but effective amount of one or more of a filler. Some examples of suitable fillers may include sodium chloride, starch, sugars, C₁-C₁₀ alkylene glycols such as propylene glycol, sulfates, PEG, urea, sodium acetate, magnesium sulfate, sodium acetate, magnesium sulfate, sodium carbonate and the like. In some embodiments, a filler can be included in an amount in the range of up to about 45 wt. %, more preferably from about 1 wt. % to about 35 wt. %.

### Hardening Agents

In some embodiments, one or more hardening agents may be included in the cleaning composition. Examples of hardening agents include urea, an amide such stearic monoethanolamide or lauric diethanolamide or an alkylamide, and the like; sulfate salts or sulfated surfactants, and aromatic sulfonates, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the active ingredients may be dispensed from the solid composition over an extended period of time.

Suitable aromatic sulfonates include, but are not limited to, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and/or sodium butyl naphthalene. Preferred aromatic sulfonates include sodium xylene sulfonate and sodium cumene sulfonate.

The amount of solidification agent included in a cleaning composition can be dictated by the desired effect. In general, an effective amount of solidification agent is considered an amount that acts with or without other materials to solidify the cleaning composition. Typically, for solid embodiments, the amount of solidification agent in a cleaning composition is in a range of about 10 to about 80% by weight of the cleaning composition, preferably in the range of about 20 to about 75% by weight more preferably in the range of about 20 to about 70% by weight of the cleaning composition. In an aspect of the invention, the solidification agent is substantially free of sulfate. For example, the cleaning composition may have less than 1 wt. % sulfate, preferably less than 0.5 wt. %, more preferably less than 0.1 wt. %. In a preferred embodiment the cleaning composition is free of sulfate.

In certain embodiments it can be desirable to have a secondary solidification agent. In compositions containing secondary solidification the composition may include a secondary solidification agent in an amount in the range of up to about 50 wt. %. In some embodiments, secondary hardening agents may be present in an amount in the range of about 5 to about 35 wt. %, often in the range of about 10 to about 25 wt. %, and sometimes in the range of about 5 to about 15 wt.-%.

In some embodiments, one or more additional hardening agents may be included in the solid cleaning composition if desired. Examples of hardening agents include an amide such stearic monoethanolamide or lauric diethanolamide, or an alkylamide, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the ingredients may be dispensed from the solid composition over an extended period of time. The composition may include a secondary hardening agent in an amount in the range of up to about 30 wt. %. In some embodiments, secondary hardening agents may be present in an amount in the range of about 5 to about 25 wt. %, often in the range of about 10 to about 25 wt. %, and sometimes in the range of about 5 to about 15 wt. %.

### Polymer

The cleaning compositions can include a polymer, or a polymer system comprised of at least one polycarboxylic acid polymer, copolymer, and/or terpolymer. Particularly suitable polycarboxylic acid polymers of the present invention, include, but are not limited to, polymaleic acid homopolymers, polyacrylic acid copolymers, and maleic anhydride/olefin copolymers.

Polymaleic acid (C₄H₂O₃)x or hydrolyzed polymaleic anhydride or cis-2-butenedioic acid homopolymer, has the structural formula:

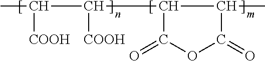

where n and m are any integer. Examples of polymaleic acid homopolymers, copolymers, and/or terpolymers (and salts thereof) which may be used for the invention are particularly preferred are those with a molecular weight of about 0 and about 5000, more preferably between about 200 and about 2000 (can you confirm these MWs). Commercially available polymaleic acid homopolymers include the Belclene 200 series of maleic acid homopolymers from BWA™ Water Additives, 979 Lakeside Parkway, Suite 925 Tucker, GA 30084, USA and Aquatreat AR-801 available from AkzoNobel. The polymaleic acid homopolymers, copolymers, and/or terpolymers may be present in cleaning compositions from about 0.01 wt. % to about 30 wt. %.

The cleaning compositions of the present invention can use polyacrylic acid polymers, copolymers, and/or terpolymers. Poly acrylic acids have the following structural formula:

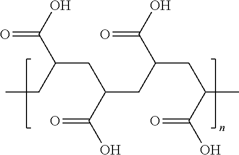

where n is any integer. Examples of suitable polyacrylic acid polymers, copolymers, and/or terpolymers, include but are not limited to, the polymers, copolymers, and/or terpolymers of polyacrylic acids, (C₃H₄O₂)ₙ or 2-Propenoic acid, acrylic acid, polyacrylic acid, propenoic acid.

In an embodiment, particularly suitable acrylic acid polymers, copolymers, and/or terpolymers have a molecular weight between about 100 and about 10,000, in a preferred embodiment between about 500 and about 7000, in an even more preferred embodiment between about 1000 and about 5000, and in a most preferred embodiment between about 1500 and about 3500. Examples of polyacrylic acid polymers, copolymers, and/or terpolymers (or salts thereof) which may be used for the invention include, but are not limited to, Acusol 448 and Acusol 425 from The Dow Chemical Company, Wilmington Delaware, USA. In particular embodiments it may be desirable to have acrylic acid polymers (and salts thereof) with molecular weights greater than about 10,000. Examples, include but are not limited to, Acusol 929 (10,000 MW) and Acumer 1510 (60,000 MW) both also available from Dow Chemical, AQUATREAT AR-6 (100,000 MW) from AkzoNobel Strawinskylaan 2555 1077 ZZ Amsterdam Postbus 75730 1070 AS Amsterdam. The polyacrylic acid polymer, copolymer, and/or terpolymer may be present in the compositions from about may be present in cleaning compositions from about 0.01 wt. % to about 30 wt. %.

Maleic anhydride/olefin copolymers are copolymers of polymaleic anhydrides and olefins. Maleic anhydride (C₂H₂(CO)₂O has the following structure:

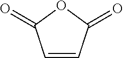

A part of the maleic anhydride can be replaced by maleimide, N-alkyl(C₁₋₄) maleimides, N-phenyl-maleimide, fumaric acid, itaconic acid, citraconic acid, aconitic acid, crotonic acid, cinnamic 10 acid, alkyl(C₁₋₁₈) esters of the foregoing acids, cycloalkyl(C₃₋₈) esters of the foregoing acids, sulfated castor oil, or the like.

At least 95 wt % of the maleic anhydride polymers, copolymers, or terpolymers have a number average molecular weight of in the range between about 700 and about 20,000, preferably between about 1000 and about 100,000.

A variety of linear and branched chain alpha-olefins can be used for the purposes of this invention. Particularly useful alpha-olefins are dienes containing 4 to 18 carbon atoms, such as butadiene, chloroprene, isoprene, and 2-methyl-1,5-hexadiene; 1-alkenes containing 4 to 8 carbon atoms, preferably C₄₋₁₀, such as isobutylene, 1-butene, 1-hexene, 1-octene, and the like.

If included, a polymer is preferably present in the cleaning compositions from about 0.01 wt. % to about 30 wt. %.

### Sanitizers/Anti-Microbial Agents

The cleaning compositions can optionally include a sanitizing agent. Sanitizing agents also known as antimicrobial agents are chemical compositions that can be used in a solid functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

It should also be understood that active oxygen compounds, such as those discussed above in the bleaching agents section, may also act as antimicrobial agents, and can even provide sanitizing activity. In fact, in some embodiments, the ability of the active oxygen compound to act as an antimicrobial agent reduces the need for additional antimicrobial agents within the composition. For example, percarbonate compositions have been demonstrated to provide excellent antimicrobial action. Nonetheless, some embodiments incorporate additional antimicrobial agents.

The given antimicrobial agent, depending on chemical composition and concentration, may simply limit further proliferation of numbers of the microbe or may destroy all or a portion of the microbial population. The terms “microbes” and “microorganisms” typically refer primarily to bacteria, virus, yeast, spores, and fungus microorganisms. In use, the antimicrobial agents are typically formed into a solid functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three-log reduction of the microbial population results in a sanitizer composition. The antimicrobial agent can be encapsulated, for example, to improve its stability.

Some examples of common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, tetramethyl phosphonium tribromide. Other antimicrobial compositions such as hexahydro-1,3,5-tris(2-hydroxyethyl)-s-triazine, dithiocarbamates such as sodium dimethyldithiocarbamate, and a variety of other materials are known in the art for their antimicrobial properties.

In embodiments of the solid cleaning composition which are phosphate-free, and/or sulfate-free, and also include an anti-microbial agent, the anti-microbial is selected to meet those requirements. Embodiments of the solid cleaning composition which include only GRAS ingredients, may exclude or omit anti-microbial agents described in this section.

In some embodiments, the cleaning composition comprises an antimicrobial component in the range of up to about 10% by wt. of the composition, in the range of up to about 5 wt. %, or in some embodiments, in the range of about 0.01 to about 3 wt. %, or in the range of 0.05 to 1% by wt. of the composition.

### Methods of Manufacturing

The solid cleaning compositions incorporating the enzyme-driven dissolution mechanism can include, but are not limited to, solid block compositions, cast solid block compositions, extruded solid block compositions, pressed solid compositions, and others. Preferably, the cleaning compositions are pressed solids. In a preferred embodiment, the solid cleaning compositions are unit dose solids.

The solid cleaning compositions may be formed using a batch or continuous mixing system. In an exemplary embodiment, a single- or twin-screw extruder is used to combine and mix one or more components at high shear to form a homogeneous mixture. In some embodiments, the processing temperature is at or below the melting temperature of the components. The processed mixture may be dispensed from the mixer by forming, casting or other suitable means, whereupon the cleaning composition hardens to a solid form. The structure of the matrix may be characterized according to its hardness, melting point, material distribution, crystal structure, and other like properties according to known methods in the art. Generally, a solid cleaning composition processed according to the method of the invention is substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

In a pressed solid process, a flowable solid, such as granular solids or other particle solids are combined under pressure. In a pressed solid process, flowable solids of the compositions are placed into a form (e.g., a mold or container). The method can include gently pressing the flowable solid in the form to produce the solid cleaning composition. Pressure may be applied by a block machine or a turntable press, or the like. Pressure may be applied at about 1 to about 3000 psi, about 5 to about 2500 psi, or about 10 psi to about 2000 psi. As used herein, the term “psi” or “pounds per square inch” refers to the actual pressure applied to the flowable solid being pressed and does not refer to the gauge or hydraulic pressure measured at a point in the apparatus doing the pressing. The method can include a curing step to produce the solid cleaning composition. As referred to herein, an uncured composition including the flowable solid is compressed to provide sufficient surface contact between particles making up the flowable solid that the uncured composition will solidify into a stable solid cleaning composition. A sufficient quantity of particles (e.g. granules) in contact with one another provides binding of particles to one another effective for making a stable solid composition. Inclusion of an optional curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provides numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid cleaning compositions. Moreover, pressed solid compositions retain its shape under conditions in which the composition may be stored or handled.

By the term “solid”, it is meant that the hardened composition will not flow and will substantially retain its shape under moderate stress or pressure or mere gravity. A solid may be in various forms such as a powder, a flake, a granule, a pellet, a tablet, a lozenge, a puck, a briquette, a brick, a solid block, a unit dose, or another solid form known to those of skill in the art. The degree of hardness of the solid cast composition and/or a pressed solid composition may range from that of a fused solid product which is relatively dense and hard, for example, like concrete, to a consistency characterized as being a hardened paste. In addition, the term “solid” refers to the state of the cleaning composition under the expected conditions of storage and use of the solid cleaning composition. In general, it is expected that the cleaning composition will remain in solid form when exposed to temperatures of up to approximately 37° C. and particularly up to approximately 48° C.

The resulting solid cleaning composition may take forms including, but not limited to: a cast solid product; an extruded, molded or formed solid pellet, block, tablet, powder, granule, flake; pressed solid; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

The following patents disclose various combinations of solidification, binding and/or hardening agents that can be utilized in the solid cleaning compositions of the present invention. The following U.S. patents are incorporated herein by reference: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

### Methods of Use

The solid compositions disclosed herein are particularly suitable for providing a solid having optimal dissolution rate for a customer or user of the solid composition to dissolve the solid for a use solution in a short period of time, such as less than about 20 minutes, less than about 15 minutes, less than about 10 minutes, or less than about 5 minutes.

The water used to dissolve the solid cleaning composition can be any temperature. Preferably it is from about 10° C. to about 100° C., more preferably at least about 15° C., at least about 20° C., at least about 25° C., at least about 30° C.; up to about 100° C., more preferably up to about 95° C.

The solid compositions dissolve to provide stable use compositions that quickly dissolve in water and form a stable, clear use solution. The stable use compositions do not exhibit precipitation upon storage and/or use. Moreover, in some embodiments the solid compositions do not require use of personal protective equipment (PPE) as they are safe for contact, including skin and eyes, e.g. based on individual use size and/or packaging.

The use compositions can be applied as concentrate compositions or further diluted. The use composition can be applied to a variety of surfaces as it is a multi-use formulation. The solid cleaning compositions are particularly suitable for cleaning hard surfaces. Suitable hard surfaces include those soiled with food soils, including food preparation surfaces that are heavily including with greasy soils. Various kitchen hygiene and hard surface applications are suitable for use of the use compositions.

Exemplary food preparation surfaces include surfaces in a restaurant, surfaces in a grocery store, and/or a household surface. In addition, various floor cleaning surfaces are included for use of the hard surface cleaning composition, including for example floors in kitchens, restaurants, the like, and/or drive-thrus.

### Preferred Embodiments

The present disclosure is further defined by the following numbered embodiments:

1. A solid cleaning composition comprising: a peroxygen source, a catalase enzyme, and a surfactant.

2. The cleaning composition of embodiment 1, wherein the peroxygen source comprises a percarbonate and the peroxygen source is in a concentration of from about 50 wt. % to about 85 wt. %.

3. The cleaning composition of embodiment 2, wherein the concentration of from about 60 wt. % to about 80 wt. %.

4. The cleaning composition of any one of embodiments 1-3, wherein the catalase enzyme is in a concentration of from about 0.2 wt. % to about 4 wt. %.

5. The cleaning composition of any one of embodiments 1-4, wherein the catalase enzyme is in a concentration of from about 0.3 wt. % to about 3 wt. %.

6. The cleaning composition of any one of embodiments 1-5, wherein the surfactant is in a concentration of from about 1 wt. % to about 35 wt. %.

7. The cleaning composition of any one of embodiments 1-6, wherein the surfactant is in a concentration of from about 5 wt. % to about 25 wt. %.

8. The cleaning composition of any one of embodiments 1-7, wherein the surfactant is an amphoteric surfactant, an anionic surfactant, a cationic surfactant, a nonionic surfactant, or a mixture thereof.

9. The cleaning composition of any one of embodiments 1-8, further comprising a builder in a concentration of from about 0.1 to about 25 wt. %.

10. The cleaning composition of embodiment 9, wherein the builder comprises a water soluble polycarboxylate polymer, an aminocarboxylic acid or salt thereof, or a mixture thereof.

11. The cleaning composition of any one of embodiments 1-10, further comprising an acid source, an alkalinity source, a corrosion inhibitor, an optical brightener, a defoaming agent, an anti-redeposition agent, a bleaching agent, a solubility modifier, a dispersant, a metal protecting agent, a preservative, a cleaning enzyme, an aesthetic enhancing agent including an odorant and/or dye, a hydrotrope, a buffer, additional cleaning agents, and mixtures thereof in an amount of from about 0.1 wt. % to about 45 wt. %.

12. The cleaning composition of any one of embodiments 1-11, wherein the cleaning composition provides a use solution having a pH of from about 3 to about 8 upon dissolution.

13. The cleaning composition of any one of embodiments 1-12, wherein the composition is substantially free of a dissolution aid other than the catalase.

14. A method of cleaning a surface comprising: contacting the solid cleaning composition of any one of embodiments 1-13 with water and dissolving the solid cleaning composition to form a use solution; contacting a soiled surface with the use solution; wherein the use solution has a pH of from about 3 to about 8.

15. The method of embodiment 14, wherein the surface is a hard surface, ware, or laundry.

16. The method of embodiment 14 or embodiment 15, further comprising rinsing the surface.

17. The method of any one of embodiments 14-16, wherein the dissolving takes less than 15 minutes.

18. The method of embodiment 17, wherein the dissolving takes less than 5 minutes.

19. The method of any one of embodiments 14-18, wherein the contacting water has a temperature of up to about 95° C.

20. A method of manufacturing the solid cleaning compositions of any one of embodiments 1-13 comprising: mixing the peroxygen source, the catalase enzyme, and the surfactant; and forming the solid cleaning composition.

21. The method of embodiment 20, wherein the forming is performed by casting, extruding, or pressing.

22. The method of embodiment 20 or embodiment 21, wherein the mixing further comprises mixing an acid source, an alkalinity source, a corrosion inhibitor, an optical brightener, a defoaming agent, an anti-redeposition agent, a bleaching agent, a solubility modifier, a dispersant, a metal protecting agent, a preservative, a builder, a cleaning enzyme, an aesthetic enhancing agent including an odorant and/or dye, a hydrotrope, a buffer, additional cleaning agents, or mixture thereof.

23. The method of any one of embodiments 20-22, wherein the mixing comprises adding a minor amount of water.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following commercially available materials were utilized in the Examples: an acrylic acid homopolymer, a catalase enzyme, a C10-16 amine oxide, cocoamidopropyl betaine sodium dioctyl sulfosuccinate, linear and branched alcohol alkoxylates, an EO PO block copolymer, a reverse block copolymer, a Guerbet alcohol alkoxylate, trisodium salt of methylglycinediacetic acid, linear alkylbenzenesulfonic acid, dioctylsulfosuccinate, light ash (sodium carbonate), citric acid, sodium bicarbonate, sodium percarbonate, and sodium silicate.

### Example 1

Solid tablets were synthesized using a catalase-based formula (Table 2), an acid/base-based formula (Table 3), and a control formula containing no dissolution aid (Table 4) to compare the dissolution rates for catalase mechanisms vs. acid/base mechanisms. The acid/base mechanism is a known method for dissolution, but suffers problems. Specifically, alkalinity is consumed during the dissolution which alters the pH. The control with no dissolution aid is used to compare the performance of the enzymatic method disclosed herein and the known acid/base mechanism.

TABLE 2

| Description | wt. % |
|---|---|
| Sodium percarbonate | 70-80 |
| Enzyme (catalase) | 0.5-2 |
| Trilon M Granules | 5-15 |
| Acusol 445 ND | 1-10 |
| Surfactant | 5-15 |

TABLE 3

| Description | wt. % |
|---|---|
| Light Ash | 50-60 |
| Trilon M Granules | 5-15 |
| Acusol 445 ND | 1-10 |
| Surfactant | 5-15 |
| Citric acid | 15-25 |

TABLE 4

| Description | wt. % |
|---|---|
| Light Ash | 70-80 |
| Trilon M Granules | 5-15 |
| Acusol 445 ND | 1-10 |
| Surfactant | 5-15 |

Ten different tablets were created using each type of method (catalase based, acid/base based, and with no dissolution aid). Each tablet could be differentiated by the surfactant used to create the tablet. Table 5 lists the ten different surfactants used and their corresponding formula numbers.

TABLE 5

| Formula # | Surfactant |
|---|---|
| 1 | amine oxide (granulate form) |
| 2 | C₅₋₁₅ Linear alcohol alkoxylate (EO 5-10 moles) |
| 3 | 1:1 Mixture (by wt.) of sodium dioctyl sulfosuccinate and C## |
| | branched alcohol alkoxylate (EO 3-8 moles, PO 3-9 moles) |
| 4 | reverse block copolymer |
| 5 | branched alcohol ethoxylate (EO 2-5 moles) |
| 6 | C₈₋₁₂ Guerbet alcohol alkoxylate (EO 7-12 moles, PO 1-3 |
| | moles) |
| 7 | C₁₀₋₁₈ linear alxohol ethoxylate (EO 5-10 moles) |
| 8 | C₁₀₋₁₆ linear alkylbenzenesulfonic acid |
| 9 | dioctylsulfosuccinate |
| 10 | cocoamidopropyl (granulate form) |

The tablets were pressed in a 20 mm tablet mold for 30 seconds at 500 psi using 3 grams of powdered formula. Each tablet was then dropped into a 1 liter beaker filled with 500 mL of room temperature 5 gpg water to initiate the dissolution test. The dissolution time was recorded as the amount of time it took for the tablet to completely break apart. Comparisons of the dissolution rates for the enzyme driven mechanism and the acid/base mechanism are depicted in the FIGURE.

The goal for the enzyme driven mechanism is not a faster performance than the existing acid/base mechanism. Both mechanisms are significantly faster than the speed of dissolution for a solid block without a dissolution aid. Rather, the goal is that while having similar dissolution speeds to overcome the problems associated with acid/base mechanisms, namely, the consumption of alkalinity source and altering of the pH. Thus, the goal in testing these formulations was to assess the speed of dissolution compared to no dissolution aid; and more importantly, comparing the consumption of alkalinity and any changes to the pH. The acid/base mechanism resulted in a use solution of about 9.5 each time. Further, it was found that the speed of dissolution could be increased by increasing the acid concentration; however, this increased the use solution pH even more, which is undesirable.

With the exception of the amine oxide formula, similar dissolution results can be observed for formulas made using the enzyme driven dissolution method and those made using the acid/base dissolution method. Despite this, the enzyme driven mechanism was still significantly faster than the control which had no dissolution aid. Thus, it was confirmed that the enzyme driven mechanism and the known acid/base mechanism provided similar performance.

More importantly, the enzyme driven mechanism overcame the problems of the acid/base dissolution aid. Specifically, the enzyme driven mechanism did not consume the alkalinity source during the dissolution and did not alter the pH. The benefits of this are important. For example, this greatly increases formulation flexibility to target a wider pH range without sacrificing fast dissolution of the tablet.

The disclosure being thus described, it will be obvious that the same may be varied in many ways. Such variations are not to be regarded as a departure from the spirit and scope of the disclosures and all such modifications are intended to be included within the scope of the following claims. The above specification provides a description of the manufacture and use of the disclosed compositions and methods. Since many embodiments can be made without departing from the spirit and scope of the disclosure, the invention resides in the claims.

What is claimed is:

1. A solid cleaning composition comprising:
from about 50 wt. % to about 85 wt. % of a peroxygen source, from about 0.2 wt. % to about 4 wt. % of a catalase enzyme, and from about 1 wt. % to about 35 wt. % of a surfactant.

2. The cleaning composition of claim 1, wherein the peroxygen source comprises a percarbonate and the peroxygen source is in a concentration of from about 60 wt. % to about 80 wt. %.

3. The cleaning composition of claim 1, wherein the catalase enzyme is in a concentration of from about 0.3 wt. % to about 3 wt. %.

4. The cleaning composition of claim 1, wherein the surfactant is in a concentration of from about 5 wt. % to about 25 wt. %.

5. The cleaning composition of claim 4, wherein the surfactant is an amphoteric surfactant, an anionic surfactant, a cationic surfactant, a nonionic surfactant, or a mixture thereof.

6. The cleaning composition of claim 1, further comprising a builder in a concentration of from about 0.1 to about 25 wt. %.

7. The cleaning composition of claim 6, wherein the builder comprises a water soluble polycarboxylate polymer, an aminocarboxylic acid or salt thereof, or a mixture thereof.

8. The cleaning composition of claim 1, further comprising an acid source, an alkalinity source, a corrosion inhibitor, an optical brightener, a defoaming agent, an anti-redeposition agent, a bleaching agent, a solubility modifier, a dispersant, a metal protecting agent, a preservative, a builder, a cleaning enzyme, an aesthetic enhancing agent including an odorant and/or dye, a hydrotrope, a buffer, additional cleaning agents, and mixtures thereof in an amount of from about 0.1 wt. % to about 45 wt. %.

9. The cleaning composition of claim 1, wherein the cleaning composition provides a use solution having a pH of from about 3 to about 8 upon dissolution.

10. The cleaning composition of claim 1, wherein the composition is substantially free of a dissolution aid other than the catalase.

11. A method of cleaning a surface comprising:
contacting the solid cleaning composition of claim 1 with water and dissolving the solid cleaning composition to form a use solution;
contacting a soiled surface with the use solution; wherein the use solution has a pH of from about 3 to about 8.

12. The method of claim 11, wherein the surface is a hard surface, ware, or laundry.

13. The method of claim 11, further comprising rinsing the surface.

14. The method of claim 11, wherein the dissolving takes less than 15 minutes.

15. The method of claim 14, wherein the dissolving takes less than 5 minutes.

16. The method of claim 11, wherein the contacting water has a temperature of up to about 95° C.

17. A method of manufacturing the solid cleaning compositions of claim 1 comprising:
mixing the peroxygen source, the catalase enzyme, and the surfactant; and
forming the solid cleaning composition.

18. The method of claim 17, wherein the forming is performed by casting, extruding, or pressing.

19. The method of claim 17, wherein the mixing further comprises mixing an acid source, an alkalinity source, a corrosion inhibitor, an optical brightener, a defoaming agent, an anti-redeposition agent, a bleaching agent, a solubility modifier, a dispersant, a metal protecting agent, a preservative, a builder, a cleaning enzyme, an aesthetic enhancing agent including an odorant and/or dye, a hydrotrope, a buffer, additional cleaning agents, or mixture thereof.

20. The method of claim 17, wherein the mixing comprises adding a minor amount of water.
